(19) United States
(12) Patent Application Publication
(10) Pub. No.: US 2008/0130852 A1
(43) Pub. Date: Jun. 5, 2008

(54) METHOD FOR DISPLAYING COST INFORMATION ON TERMINAL DEVICES IN REAL TIME

(75) Inventor: Mingyu Li, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/949,505

(22) Filed: Dec. 3, 2007

Related U.S. Application Data
(63) Continuation of application No. PCT/CN2006/001750, filed on Jul. 19, 2006.

(30) Foreign Application Priority Data
Aug. 5, 2005 (CN) 200510088380.X

(51) Int. Cl. H04M 15/00

(52) U.S. Cl. 379/130

(57) ABSTRACT

The present invention provides a method for displaying cost information on a terminal device in real time, including: calculating cost in real time during a call by a network, and transmitting obtained cost information to the terminal device; displaying the cost information by the terminal device after receiving the cost information. According to the present invention, the rate is totally under the control of the network, which guarantees the security of the charging process; in addition, the network performs charging in a centralized manner, which eliminates errors resulting from the terminal device and thus achieves an accurate charging process; furthermore, the rate is totally under the control of the network, and the rate may be adjusted flexibly based on the call duration, hence the present invention provides considerable flexibility.

### BACKGROUND OF THE INVENTION

1. Field of the Invention

The present invention relates to communication technologies, and particularly, to a system and a method for displaying cost information on a terminal device in real time.

2. Background of the Invention

The function of displaying cost information on a terminal device enables the terminal device, when a calling user finishes a call, to show the cost information of the call on the display of the device. The function of displaying cost information in real time enables the terminal device to show the cost information of a call in real time in every charging period during the call. For example, if a charging period is 6 seconds and the charging rate is RMB0.01/6 s, the terminal device will display the total cost information every 6 seconds during the call.

Two methods for displaying cost information in real time according to the prior art are described and analyzed as follows.

One of the methods includes: saving charging information, such as the charging rate and the charging period in the terminal device; starting timing by the terminal device when a calling user begins the call; calculating the cost based on the saved charging rate each time the charging period expires; and displaying the cost information obtained through calculation.

It can be seen from the above technical solution that the charging process is performed entirely by the terminal device. The charging information such as the charging rate and the charging period is save in the terminal device, and may be easily manipulated. Therefore, the security of this method is of a relatively low level. Further, the accuracy of the charging process also depends on the terminal device, which results in frequent errors in the charging process. The rate information is configured on the terminal device, which requires complicated rate maintenance process and lacks flexibility.

The other method in the prior art includes: issuing the charging rate to the terminal device by the network when the calling user begins the call; starting timing by the terminal device at the same time; calculating the cost based on the received rate each time a charging period expires; and displaying the cost information obtained through calculation.

The technical solution of the second method has the same problem as that of the first method, i.e., accuracy of the charging process depends on the terminal device, which results in frequent errors in the charging process. Furthermore, according to the technical solution of the second method., because the charging rate is issued to the terminal device only when the call begins, the terminal device may not be provided with flexible rates concerning the currently existing various preferential charging policies. So this method also lacks flexibility in practice.

### SUMMARY OF THE INVENTION

The present invention provides a method for displaying cost information on a terminal device in real time so as to achieve accurate and. flexible charging.

A method for displaying cost information on a terminal device in real time, includes:

calculating, by a network, cost in real time during a call, and transmitting obtained cost information to a terminal device; and

displaying the cost information by the terminal device in real time.

### BRIEF DESCRIPTION OF THE DRAWINGS

FIG. 1 shows a network structure of an intelligent network;

FIG. 2 is a flow chart according to an embodiment of the present invention.

### DETAILED DESCRIPTION OF PREFERRED EMBODIMENTS

An embodiment of the present invention is described hereafter with reference to the accompanying drawings so that those skilled in the art can understand and implement the present invention.

The present invention provides a solution for displaying cost information on a terminal device in real time, which includes: charging by the network in real time for the call and transmitting the cost information to the terminal device; and displaying the cost information by the terminal device after receiving the cost information.

Charging for the call in real time by the network usually includes: counting the duration of the call and calculating in real time the cost for the call based on a corresponding rate and the duration of the call.

Display protocols may be configured, so that the terminal device may negotiate with the network to determine which display protocol is to be employed on demand. In this case, charging for the call in real time by the network includes: determining the cost information to be transmitted according to the display protocol determined by the network: and the terminal device, and calculating in real time to generate the cost information to be transmitted.

If the determined display protocol prescribes that the cost information to be transmitted includes the cost for the present call only, the network counts the duration of the call and then calculates in real time the cost for the call based on a corresponding rate and the duration of the call, so that the cost information is generated.

If the determined display protocol prescribes that the cost information to be transmitted shall include not only the cost for the present call, but also the total cost within a period of time, a process of calculating the total cost within the period shall be added into the method. Calculating the total cost within the period includes: adding the total cost for previous calls within the period and the cost for the present call.

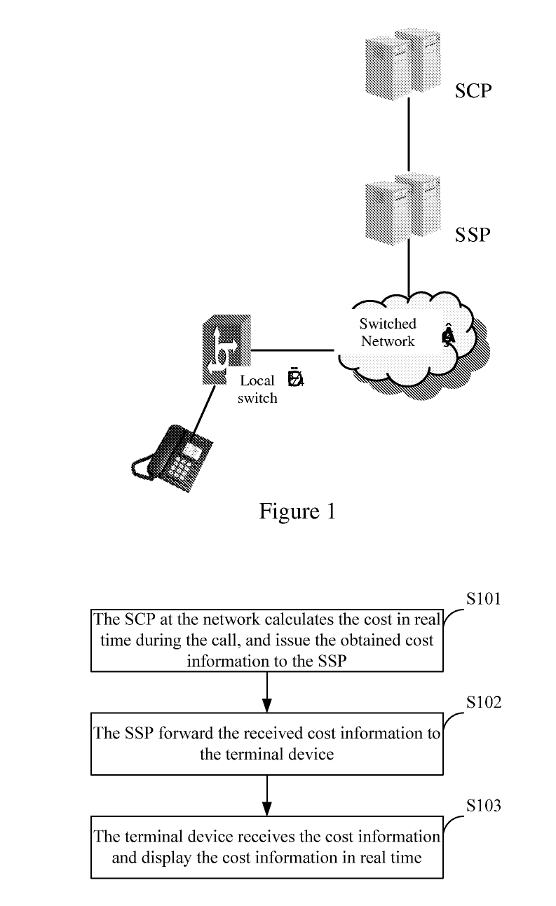

As explained in the above description, according to an embodiment of the present invention, the network generates and displays the cost securely, accurately and in real time. An embodiment of the present invention is applied to an intelligent network, which includes a Service Control Point (SCP), a Service Switching Point (SSP), a switched network, a local switch, and a terminal device such as a telephone, as shown in FIG. 1.

The call process is controlled by the intelligent network, so the SCP of the intelligent network, which serves as a cost calculating device, may perform a realtime calculation of the cost for the call and issue the cost information to the SSP periodically. The SSP, which serves as a cost information forwarding device, receives the cost information and forwards the cost information to the terminal device via the communication link. Periodically issuing the cost information from the SCP to the SSP includes that the SCP issues the cost information in every charging period. At present a charging period is usually 6 seconds, so the SCP may issue the cost information to the SSP every 6 seconds.

FIG. 2 shows the work flow according to an embodiment of the present invention in the intelligent network, including:

Block S101: The SCP of the network calculates the cost for the call in real time and issues the cost information to the SSP.

In this block, the SCP of the network first counts the duration of the call and calculates the charge for the call in real time based on the corresponding rate and the call duration, and then issues the cost information to the SSP. Issuing the cost information from the SCP to the SSP during the call may be implemented by extending the interaction operations in accordance with the Intelligent Network Application Procedure (INAP), or be implemented by providing an internal private protocol, e.g., an extension of Play Announcement (PA). For example, a PA operation may be indicated to be a cost information issuing operation, and the cost information carried in the operation is transmitted to the SSP.

Further, the SCP and the terminal device may negotiate to determine a cost information display protocol, which prescribes to display the cost information including only the cost for the present call, or the cost information including both the cost of the present call and the total cost of the whole month. Therefore, in the process of calculating the cost for the call in real time, the SCP may determine the cost information to be transmitted according to the display protocol between the SCP and the terminal device before calculating the cost for the call.

Block S102: The SSP transmits the received cost information to the terminal device.

In this block, the cost information may be transmitted to the terminal device in the form of audio signal, i.e., the cost information is transmitted to the terminal device during the call according to audio coding approaches, e.g., Frequency Shift Keying (FSK) or Dual-Tone Multi,-Frequency (DTMF). Such a transmission mode may produce audible sound, so the transmission duration of the cost information is limited to an extremely short period in order not to affect the communication quality, e.g., the cost information is transmitted in 50 ms, which is negligible to human ears.

In accordance with an embodiment of the present invention, the transmission duration of the cost information may further be adjusted according to the employed audio coding approaches and the information volume of the cost information. to be transmitted. For example, when the information volume is low, the transmission duration may further be shortened, e.g., to 30 ms, to minimize the influence brought by the transmission of the cost information to the communication quality.

Block S103: the terminal device displays the cost information in real time after receiving the cost information.

It can be seen from the technical solution of the present invention that, the network performs realtime calculation of the cost for the call and transmits the cost information to the terminal device; the terminal device displays the cost information after receiving the cost information, therefore the rate is totally under the control of the network, which guarantees the security of the charging process. Further, according to an embodiment of the present invention, the network calculates the cost in a centralized manner, which eliminates errors resulting from the terminal device and thus achieves accuracy of the charging process. Furthermore, since the rate is totally under the control of the network, the rate may be adjusted flexibly by the network based on the call duration. The present invention provides considerable flexibility.

The foregoing is only preferred embodiments of this invention. The protection scope of this invention, however, is not limited to the above description. Any change or substitution, within the technical scope disclosed by this invention, easily occurring to those skilled in the art should be covered by the protection scope of this invention. Therefore, the protection scope of the present invention should be determined according to claims.

What is claimed is:

1. A method for displaying cost information on a terminal device in real time, comprising:
calculating, by a network, cost in real time during a call, and transmitting obtained cost information to a terminal device; and
displaying the cost information by the terminal device in real time.

2. The method of claim 1, wherein the process of calculating the cost in real time comprises:
counting a duration of the call and calculating in real time the cost for the call based on a corresponding rate aid the duration of the call.

3. The method of claim 1, wherein the process of calculating the cost in real time comprises:
determining the cost information to be transmitted according to a determined display protocol between the network and the terminal device; and
calculating in real time to generate the cost information to be transmitted.

4. The method of claim 3, wherein the cost information to be transmitted comprises a cost for the current call; and the process of calculating in real time to generate the cost information to be transmitted comprises:
calculating the cost for the current cal, which further comprises counting a duration of the call and calculating the cost for the call in real time according to a corresponding rate and the duration of the call.

5. The method of claim 3, wherein the cost information to be transmitted comprises a total cost within a period of ti me; and the process of the network calculating in real time to generate the cost information to be transmitted comprises:
calculating a cost of the current call; and
calculating the total cost within the period of time, which further comprises adding the cost of the current call to a total cost of previous calls.

6. The method of claim 1, wherein the network transmits the cost information to the terminal device according to an audio coding approach.

7. The method of claim 6, wherein the process of transmitting the cost information to the terminal device further comprises: transmitting the cost information to the terminal device in a predetermined transmission time.

8. The method of claim 7, wherein the predetermined transmission time is configured based on the audio coding approach and the information volume of the cost information.

9. The method of claim 6, wherein the audio coding approach comprises: Frequency Shift Keying FSK or Dual-Tone Multi-Frequency DTMF.

10. The method of any of Claim 1, wherein, the process of calculating the cost in real time comprises:
calculating the cost in real time by a cost calculating device of the network and issuing the obtained cost information to a cost information forwarding device of the network; and
the process of the network transmitting obtained cost information to the terminal device comprises:
transmitting the received cost information to the terminal device by the cost information forwarding device of the network.

11. The method of claim 10, wherein the process of issuing the cost information to the cost information forwarding device of the network comprises:
issuing the cost information to the cost information forwarding device through a network application layer protocol or an internal private protocol.
